(19) United States
(12) Patent Application Publication
(10) Pub. No.: US 2024/0205819 A1
(43) Pub. Date: Jun. 20, 2024

(54) COMMUNICATION METHOD, APPARATUS, AND DEVICE

(71) Applicant: GUANGDONG OPPO MOBILE TELECOMMUNICATIONS CORP., LTD., Dongguan (CN)

(72) Inventors: Yang XU, Dongguan (CN); Jingran CHEN, Dongguan (CN)

(73) Assignee: GUANGDONG OPPO MOBILE TELECOMMUNICATIONS CORP., LTD., Dongguan (CN)

(21) Appl. No.: 18/594,886

(22) Filed: Mar. 4, 2024

Related U.S. Application Data
(63) Continuation of application No. PCT/CN2021/120806, filed on Sep. 26, 2021.

(51) Int. Cl. H04W 48/20; H04W 48/16; H04W 72/543

(52) U.S. Cl. CPC H04W 48/20; H04W 48/16; H04W 72/543

(57) ABSTRACT

Provided are a communication method, apparatus, and device. The method includes: a first node receives a first request message from a second node, the first request message carrying condition information; the first node determines a condition satisfaction situation of each terminal in multiple terminals on the basis of the condition information, and determines a candidate terminal from the multiple terminals on the basis of the condition satisfaction situation of each of the multiple terminals; the first node sends a first request reply message to the second node, the first request reply message carrying indication information of the candidate terminal.

### CROSS-REFERENCE TO RELATED APPLICATIONS

This application is a continuation application of International Patent Application No. PCT/CN2021/120806 filed on Sep. 26, 2021, the disclosure of which is incorporated herein by reference in its entirety.

### TECHNICAL FIELD

Embodiments of the disclosure relate to the field of mobile communication technology, and particularly to a communication method and apparatus, and a communication device.

### BACKGROUND

In some scenes, one terminal may process a task by itself. In some other scenes, multiple terminals may collaborate to process one task.

To improve the efficiency in processing a task, either by a single terminal or by multiple terminals, a suitable terminal is required to be selected to process the task. There is a pressing need for determining whether a terminal is suitable or how to select a suitable terminal.

### SUMMARY

Embodiments of the disclosure provide a communication method and apparatus, a communication device, a chip, a computer-readable storage medium, a computer program product, and a computer program.

A communication method according to embodiments of the disclosure includes operations as follows.

A first node receives a first request message sent by a second node. The first request message includes condition information.

The first node determines a condition satisfaction circumstance of a respective terminal of multiple terminals based on the condition information, and determines a candidate terminal from the multiple terminals based on the condition satisfaction circumstance of the respective terminal.

The first node sends a first request reply message to the second node. The first request reply message includes indication information for the candidate terminal.

A communication method according to embodiments of the disclosure includes operations as follows.

A first node receives a first request message from a second node. The first request message includes an identifier of a terminal and condition information.

The first node determines a condition satisfaction value of the terminal based on the condition information.

The first node sends a first request reply message to the second node. The first request reply message includes the condition satisfaction value of the terminal.

A communication method according to embodiments of the disclosure includes operations as follows.

A second node sends a first request message to a first node. The first request message includes condition information. The condition information is configured for the first node to determine a condition satisfaction circumstance of a respective terminal of multiple terminals, and determine a candidate terminal from the multiple terminals based on the condition satisfaction circumstance of the respective terminal.

The second node receives a first request reply message sent by the first node. The first request reply message includes indication information for the candidate terminal.

A communication method according to embodiments of the disclosure includes operations as follows.

A second node sends a first request message to a first node. The first request message includes an identifier of a terminal and condition information. The identifier of the terminal and the condition information are configured for the first node to determine a condition satisfaction value of the terminal.

The second node receives a first request reply message from the first node. The first request reply message includes the condition satisfaction value of the terminal.

A communication apparatus according to embodiments of the disclosure applies to a first node. The communication apparatus includes a receiving unit, a determining unit, and a sending unit.

The receiving unit is configured to receive a first request message from a second node. The first request message includes condition information.

The determining unit is configured to determine a condition satisfaction circumstance of a respective terminal of multiple terminals based on the condition information, and determine a candidate terminal from the multiple terminals based on the condition satisfaction circumstance of the respective terminal.

The sending unit is configured to send a first request reply message to the second node. The first request reply message includes indication information for the candidate terminal.

A communication apparatus according to embodiments of the disclosure applies to a first node. The communication apparatus includes a receiving unit, a determining unit, and a sending unit.

The receiving unit is configured to receive a first request message from a second node. The first request message includes an identifier of a terminal and condition information,

The determining unit is configured to determine a condition satisfaction value of the terminal based on the condition information,

The sending unit is configured to send a first request reply message to the second node. The first request reply message includes the condition satisfaction value of the terminal.

A communication apparatus according to embodiments of the disclosure applies to a second node. The communication apparatus includes a sending unit and a receiving unit.

The sending unit is configured to send a first request message to a first node. The first request message includes condition information. The condition information is configured for the first node to determine a condition satisfaction circumstance of a respective terminal of multiple terminals, and determine a candidate terminal from the multiple terminals based on the condition satisfaction circumstance of the respective terminal.

The receiving unit is configured to receive a first request reply message sent by the first node. The first request reply message includes indication information for the candidate terminal.

A communication apparatus according to embodiments of the disclosure applies to a second node. The communication apparatus includes a sending unit and a receiving unit.

The sending unit is configured to send a first request message to a first node. The first request message includes an identifier of a terminal and condition information. The identifier of the terminal and the condition information are configured for the first node to determine a condition satisfaction value of the terminal.

The receiving unit is configured to receive a first request reply message from the first node. The first request reply message includes the condition satisfaction value of the terminal.

A communication device according to embodiments of the disclosure includes a processor and a memory. The memory is configured to store a computer program. The processor is configured to call and run the computer program stored in the memory to implement a foregoing communication method.

A chip according to embodiments of the disclosure is configured to implement a foregoing communication method.

Specifically, the chip includes a processor configured to call and run a computer program in a memory, causing a device installed with the chip to implement a foregoing communication method.

A computer-readable storage medium according to embodiments of the disclosure has stored thereon a computer program. The computer program causes a computer to perform a foregoing communication method.

A computer program product according to embodiments of the disclosure includes computer program instructions. The computer program instructions cause a computer to perform a foregoing communication method.

A computer program according to embodiments of the disclosure causes a computer to perform a foregoing communication method when the computer program is run on the computer.

With the foregoing technical solution, on one hand, a first node may determine respective condition satisfaction circumstances of multiple terminals based on condition information, and determine a candidate terminal from the multiple terminals based on the respective condition satisfaction circumstances of the multiple terminals, so that the candidate terminal which satisfies the condition information to the maximum extent can be selected from the multiple terminals; and on the other hand, based on the condition information, the first node may determine a condition satisfaction value of a terminal and/or determine whether the condition satisfaction value of the terminal is greater than or equal to a condition satisfaction threshold, so that a condition satisfaction circumstance of the terminal can be measured based on the condition satisfaction value, and the criterion for determining a suitable terminal is clarified by comparing the condition satisfaction value of the terminal to the condition satisfaction threshold.

### BRIEF DESCRIPTION OF THE DRAWINGS

Drawings illustrated here are provided for helping further understanding of the disclosure, and form a part of the disclosure. Illustrative embodiments of the disclosure and the descriptions thereof are for explaining the disclosure, and do not form improper limitations to the disclosure.

FIG. 1 is a diagram of a scene in which embodiments of the disclosure are applied.

FIG. 2 is a diagram of a typical architecture of federated learning according to embodiments of the disclosure.

FIG. 3 is a diagram of communicating quality of information (QoI) according to embodiments of the disclosure.

FIG. 4 is flowchart 1 of a communication method according to embodiments of the disclosure.

FIG. 5 is flowchart 2 of the communication method according to embodiments of the disclosure.

FIG. 6 is a flowchart of interaction in the communication method according to embodiments of the disclosure.

FIG. 7 is flowchart 3 of the communication method according to embodiments of the disclosure.

FIG. 8 is flowchart 4 of the communication method according to embodiments of the disclosure.

FIG. 9 is diagram 1 of a structural composition of a communication apparatus according to embodiments of the disclosure.

FIG. 10 is diagram 2 of the structural composition of the communication apparatus according to embodiments of the disclosure.

FIG. 11 is diagram 3 of the structural composition of the communication apparatus according to embodiments of the disclosure.

FIG. 12 is diagram 4 of the structural composition of the communication apparatus according to embodiments of the disclosure.

FIG. 13 is a diagram of a structure of a communication device according to embodiments of the disclosure.

FIG. 14 is a diagram of a structure of a chip according to embodiments of the disclosure.

FIG. 15 is a block diagram of a communication system according to embodiments of the disclosure.

### DETAILED DESCRIPTION

A technical solution in embodiments of the disclosure is illustrated hereinafter with reference to the drawings of the embodiments of the disclosure. The embodiments herein are some, instead of all, embodiments of the disclosure. Based on the embodiments of the disclosure, a person having ordinary skill in the art may acquire another embodiment without creative effort, and any such embodiment falls within the scope of the disclosure.

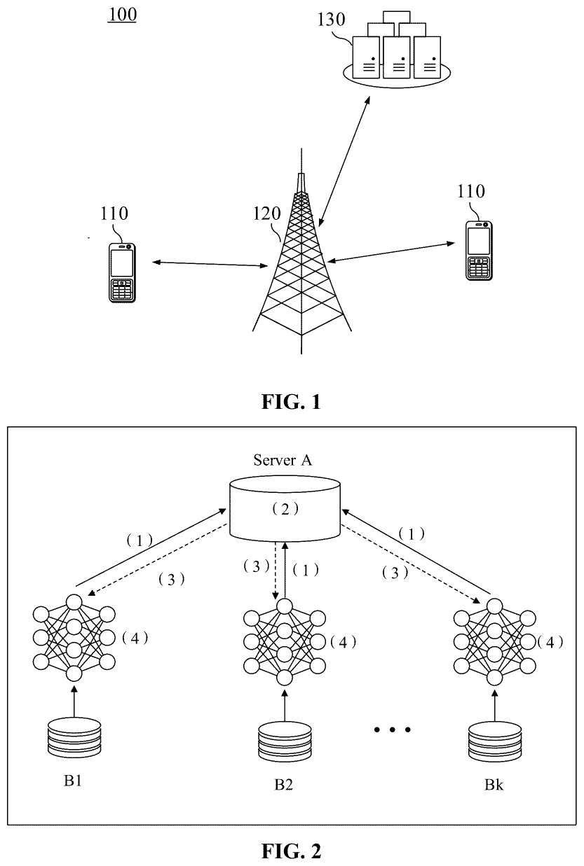

FIG. 1 is a diagram of a scene in which embodiments of the disclosure are applied.

As illustrated in FIG. 1, the communication system 100 may include terminals 110 and a network device 120. The network device 120 may communicate with a terminal 110 through an air interface. Multi-service transmission between a terminal 110 and the network device 120 is supported.

Note that embodiments of the disclosure are illustrated taking the communication system 100 as an example. However, embodiments of the disclosure are not limited to the communication system. That is, the technical solution according to embodiments of the disclosure may apply to various communication systems, such as a long term evolution (LTE) system, an LTE time division duplex (TDD) system, a universal mobile telecommunication system (UMTS), an internet of things (IoT) system, a narrow band internet of things (NB-IoT) system, an enhanced machine-type communications (eMTC) system, a 5th generation (5G) communication system (also referred to as a new radio NR communication system), or a future communication system, etc.

In the communication system 100 illustrated in FIG. 1, the network device 120 may be an access network device communicating with a terminal 110. The access network device may provide a communication coverage for a specific geographical region, and may communicate with a terminal 110 (such as a UE) located in the covered region.

The network device 120 may be a base station (BS) (evolutional node B, eNodeB or eNB) in a long term evolution (LTE) system, or a next generation radio access network (NG RAN) device, or a base station (next generation NodeB, gNB) in a NR system, or a radio controller in a cloud radio access network (CRAN). Alternatively, the network device 120 may be a relay station, an access point, an onboard device, a wearable device, a hub, a switch, a bridge, a router, or a network device in a future evolved public land mobile network (PLMN), etc.

A terminal 110 may be any terminal, including but not limited to one connected to the network device 120 or another terminal through a wired or wireless connection.

For example, the terminal 110 refers to an access terminal, a user equipment (UE), a user unit, a user station, a mobile station, a remote station, a remote terminal, a mobile device, a user terminal, a terminal, a wireless communication device, a user agent, or a user apparatus, etc. The access terminal may be a cell phone, a cordless phone, a session initiation protocol (SIP) phone, an IoT device, a handheld satellite terminal, a wireless local loop (WLL) station, a personal digital assistant (PDA), a handheld device capable of radio communication, a computing device, or another processing device connected to a radio modem, an onboard device, a wearable device, a terminal in a 5G network, or a terminal in a future evolved network, etc.

A terminal 110 may be configured for device to device (D2D) communication.

The radio communication system 100 may further include a core device 130 in communication with a base station. The core device 130 may be a 5G core (5GC) device, such as an access and mobility management function (AMF), an authentication server function (AUSF), a user plane function (UPF), a session management function (SMF), etc. In an implementation, the core device 130 may also be an evolved packet core (EPC) device of a LTE network, such as a session management function+core packet gateway (SMF+PGW-C) device. Note that the SMF+PGW-C device may implement functions of both SMF and PGW-C. During network evolution, the core device may also be referred to by another name, or form new network entities by core function division, which is not limited in embodiments of the disclosure.

A connection may be established to implement communication between functional units in the communication system 100 through a next generation (NG) network interface.

For example, a terminal may establish, through an NR interface, an air interface connection to the access network device to transmit user plane data and control plane signalling. The terminal may establish a control plane signalling connection to the AMF through an NG interface 1 (N1). The access network device, such as a next generation radio access NodeB (gNB), may establish a user plane data connection to the UPF through an NG interface 3 (N3). The access network device may establish a control plane signalling connection to the AMF through an NG interface 2 (N2). The UPF may establish a control plane signalling connection to the SMF through an NG interface 4 (N4). The UPF may exchange user plane data with a data network through an NG interface 6 (N6). The AMF may establish a control plane signalling connection to the SMF through an NG interface 11 (N11). The SMF may establish a control plane signalling connection to a policy control function (PCF) through an NG interface 7 (N7).

FIG. 1 illustrates one base station, one core device, and two terminals. In an implementation, the radio communication system 100 includes multiple base stations and each base station may cover another number of terminals, which is not limited in embodiments of the disclosure.

Note that FIG. 1 just illustrates a system to which the disclosure is applicable. The method according to embodiments of the disclosure may also be applied to another system. In addition, terms “system” and “network” in the disclosure are often interchangeable in usage. A term “and/or” in the disclosure describes just an association between associated objects, including three possible relationships. For example, A and/or B may represent three cases, namely, existence of just A, existence of both A and B, or existence of just B. A slash mark “/” in the disclosure generally represents an “or” relationship between two associated objects that come respectively before and after the mark per se. Further note that “indicate” mentioned in embodiments of the disclosure may refer to direct indication or indirect indication, and may further mean an association relation. For example, by saying that A indicates B, it may mean that A indicates B directly, e.g., B may be acquired through A; it may mean that A indicates B indirectly, e.g., A indicates C and B may be acquired through C; or it may mean an association relation between A and B. Further note that a term “corresponding” mentioned in embodiments of the disclosure may mean a direct correspondence or an indirect correspondence between two items, an association between the two, or a relation of indicating and being indicated, configuring and being configured, etc. Further note that “predefining” or “predefined rule” mentioned in embodiments of the disclosure may be achieved by saving a corresponding code and/or table beforehand in a device (including a terminal and a network device, for example), or in another mode that may be configured to indicate related information, the specific implementation of which is not limited in embodiments of the disclosure. For example, “predefined” may be as defined in a protocol. Further note that in embodiments of the disclosure, a protocol may refer to a standard protocol in the field of communications, and may include, for example, an LTE protocol, an NR protocol, and a related protocol applying to a future communication system, which is not limited in embodiments of the disclosure.

To facilitate understanding the technical solution according to embodiments of the disclosure, art related to embodiments of the disclosure is illustrated hereinafter. The following related art may be combined, as optional schemes, with the technical solution according to embodiments of the disclosure as needed. All resulting solutions thus acquired fall in the scope of embodiments of the disclosure.

In some scenes, one terminal may process a task by itself. In some other scenes, multiple terminals may collaborate to process one task.

Description is made hereinafter taking a federated learning task as an example. In a federated learning task, multiple terminals collaborate to process one learning task.

In conventional machine learning modeling, data needed in model training in general are gathered into a data center, and then a model is trained. After that, prediction is made through the trained model. In horizontal federated learning, which may be deemed as sample-based distributed model training, all data are distributed to different machines, each machine may download a model from a server, train the model using local data, and then return a parameter for update to the server. The server may aggregate the parameters returned by the respective machines, update the model, and then feed the latest model back to each machine. In this process, each machine has the same and complete model, the machines do not communicate with or depend on each other, and each machine may also make prediction independently. The process may be deemed as sample-based distributed model training.

FIG. 2 is a typical architecture of federated learning. Server A is a manager, and is configured to send a model to respective distributed nodes, update the model according to feedbacks from the distributed nodes, and send the updated model again to the distributed nodes for a next round of model training. B1, B2, . . . , and Bk in FIG. 2 may be deemed as multiple different distributed nodes (i.e., participants). The distributed nodes have respective local data. Each of the distributed nodes trains the model sent by the server A locally, and then return the parameter for update to the server A, to avoid sending the local data to others (such as the server A). The distributed nodes (i.e., participants) may be network elements at the network side or may be terminals. As illustrated in FIG. 2, a flow of federated learning is as follows.

(1) The participants may download the latest model from the server A, respectively. Each participant may train the model using local data, encrypt an acquired gradient vector, and then upload the encrypted gradient vector to the server A.

(2) The server A may aggregate respective gradient vectors from the participants, and update the model according to an aggregated gradient vector.

(3) The server A may return an updated model to the participants.

(4) The participants may update their respective models.

Multiple iterations are performed in operation (2) to operation (4), and multiple times of update of the model are implemented. Model training is completed under a certain condition (e.g., a certain number of iterations being completed or a computed value of a loss function of the model being less than a preset value).

Member (i.e., participant) selection plays a significant role in a federated learning task. Quality of member selection may have a significant impact on performance of federated learning, such as a rate of convergence, a model training result, etc.

Note that although the above description is made taking a federated learning task as an example, to improve the efficiency in processing any task either by a single terminal or by multiple terminals, a suitable terminal is required to be selected to process the task. There is a pressing need for determining whether a terminal is suitable or how to select a suitable terminal. To this end, a technical solution according to embodiments of the disclosure is proposed as follows.

To facilitate understanding the technical solution according to embodiments of the disclosure, the technical solution of the disclosure is elaborated hereinafter with specific embodiments. The above related art may be combined, as optional schemes, with the technical solution according to embodiments of the disclosure as needed. All resulting solutions thus acquired shall fall in the scope of embodiments of the disclosure. Embodiments of the disclosure include at least some of the following content.

Note that the technical solution according to embodiments of the disclosure may apply to any communication system, including but not limited to a 5G system (5GS), a 6G system (6GS), etc.

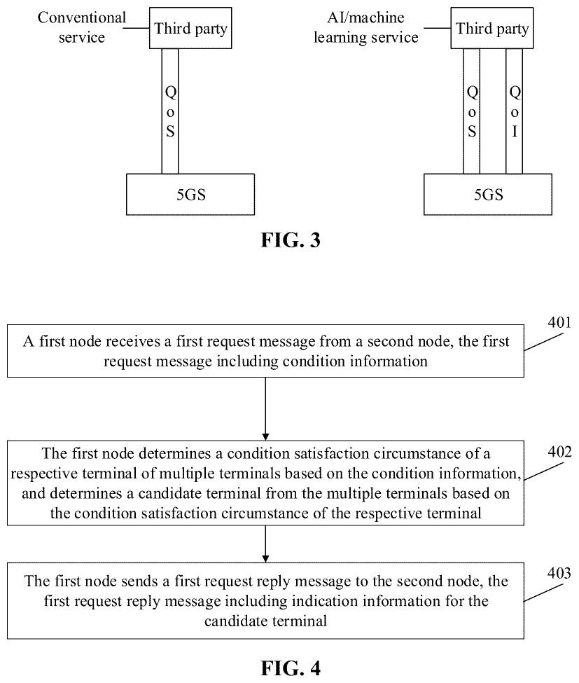

Referring to FIG. 3, a third party (i.e., the second node in the solution of the disclosure as follows) may be an application server or a terminal. The efficiency of a conventional service (as illustrated on the left of FIG. 3) is related to quality of service (QoS). The efficiency of artificial intelligence (AI) or machine learning service (as illustrated on the right of FIG. 3) is related not only to QoS, but also to quality of information (QoI). Here, the third party may be provided with QoI acquired by the 5GS through analysis, enabling the third party to make a better decision for the service, such as enabling a terminal with better third-party condition information to process the service. Note that although FIG. 3 illustrates the example of the AI or machine learning service, a service type is not limited hereto, and other types of services may also apply.

FIG. 4 is flowchart 1 of a communication method according to embodiments of the disclosure. As illustrated in FIG. 4, the communication method includes operations as follows.

At operation 401, a first node receives a first request message from a second node. The first request message includes condition information.

In some implementations, the first node may be a first core network element. Here, with respect to an existing core, the first core network element may be a new functional network element, or an existing functional network element. A name of the first core network element is not limited to the disclosure.

In some implementations, the second node may be a terminal or an application server.

In embodiments of the disclosure, the second node sends the first request message to the first node, and accordingly, the first node receives the first request message from the second node. Here, the first request message is configured to request for a recommended candidate terminal. The first request message may include the condition information. Here, the condition information is configured to select the candidate terminal.

In embodiments of the disclosure, the condition information is configured for determining one or more conditions. For example, the condition information may include indication information for the one or more conditions.

In some implementations, the condition information is configured for determining at least one of a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

In the solution, in an implementation, it may be measured against a respective threshold whether the transmission rate condition, the speed condition, the time condition, the QoS condition, etc., is satisfied.

For example, it is measured against a transmission rate threshold whether the transmission rate condition is satisfied. A terminal satisfies the transmission rate condition if a transmission rate of the terminal is greater than or equal to the transmission rate threshold.

For example, it is measured against a speed threshold whether the speed condition is satisfied. A terminal satisfies the speed condition if a speed of the terminal is greater than or equal to the speed threshold.

For example, it is measured against a time threshold whether the time condition is satisfied. A terminal satisfies the time condition if the terminal stays at a specified region for a time period of at least the time threshold.

For example, it is measured against a QoS threshold whether the QoS condition is satisfied. For some QoS parameters, a terminal satisfies the QoS condition if a QoS value of the terminal is greater than or equal to the QoS threshold. For some other QoS parameters, a terminal satisfies the QoS condition if the QoS value of the terminal is less than or equal to the QoS threshold.

Further, in some implementations, a condition determined by the condition information may further include an additional condition. The additional condition may include at least one of a condition satisfaction accuracy or a condition satisfaction effective time.

Here, the condition satisfaction accuracy may be represented by a confidence value. In other words, the confidence value may represent the accuracy of prediction of condition satisfaction.

Here, the condition satisfaction effective time may refer to a time point when the condition is satisfied or a time period during which the condition is satisfied.

Here, note that for most conditions determined by the condition information, in general it is the network that predicts whether a condition is satisfied or predicts a satisfaction score of the condition. A condition may be further associated with the additional condition such as condition satisfaction accuracy and/or condition satisfaction effective time due to an issue such as accuracy, effective time, etc., of prediction.

Note that whether a condition is satisfied or a probability of satisfying the condition (corresponding to a satisfaction score in satisfying the condition in the solution below) may depend on just the condition per se, or may depend on both the condition per se and an additional condition associated with the condition. As an example, the additional condition of condition 1 is additional condition 1. As an implementation, the satisfaction score of condition 1 is deemed to be 100% in case condition 1 is satisfied. As another implementation, the satisfaction score of condition 1 is deemed to be 100% in case both condition 1 and the additional condition 1 are satisfied.

At operation 402, the first node determines a condition satisfaction circumstance of a respective terminal of multiple terminals based on the condition information, and determines a candidate terminal from the multiple terminals based on the condition satisfaction circumstance of the respective terminal.

In embodiments of the disclosure, the condition information is configured for determining one or more conditions. The first node may determine the condition satisfaction circumstance of the respective terminal of the multiple terminals in a mode as follows.

In mode 1, the first node may determine a respective satisfaction score of the respective terminal in satisfying each of the one or more conditions, and determine a condition satisfaction value of the respective terminal based on the respective satisfaction score of the respective terminal in satisfying each of the one or more conditions. Here, the condition satisfaction value of a terminal may represent the condition satisfaction circumstance of the terminal.

In some implementations, a satisfaction score in satisfying a condition may be a number greater than or equal to 0 and less than or equal to 1, and may represent a degree to which the condition is satisfied. As an example, satisfaction score 1 in satisfying a condition represents 100% satisfaction of the condition. Satisfaction score 0 in satisfying a condition represents that the condition is not satisfied. Satisfaction score X % in satisfying a condition represents a probability X % that the condition is satisfied.

Here, a satisfaction score in satisfying a condition may be assigned as needed. Taking the QoS condition as an example, a first score may be assigned as a satisfaction score of a terminal in satisfying the QoS condition if a QoS value of the terminal is within a first range of values. A second score may be assigned as a satisfaction score of the terminal in satisfying the QoS condition if the QoS value of the terminal is within a second range of values. A third score may be assigned as a satisfaction score of the terminal in satisfying the QoS condition if the QoS value of the terminal is within a third range of values. In an implementation, the greatest value of the first range of values is less than the least value of the second range of values, and the greatest value of the second range of values is less than the least value of the third range of values. For example, the first range of values may be a range of values less than QoS value 1, the second range of values may be a range of values from the QoS value 1 to QoS value 2, and the third range of values may be a range of values from the QoS value 2 to QoS value 3. Taking the condition satisfaction accuracy (i.e., confidence) in the additional condition as an example, a first score may be assigned as a satisfaction score of a terminal in satisfying a condition if a condition satisfaction accuracy of the terminal is within a first accuracy range. A second score may be assigned as a satisfaction score of the terminal in satisfying the condition if the condition satisfaction accuracy of the terminal is within a second accuracy range. A third score may be assigned as a satisfaction score of the terminal in satisfying the condition if the condition satisfaction accuracy of the terminal is within a third accuracy range.

Note that a foregoing satisfaction score in satisfying a condition may further be assigned in another mode. Any mode that can be used to assess the degree to which the condition is satisfied may be used to assign a satisfaction score in satisfying the condition.

In some implementations, the one or more conditions may have corresponding weight(s), respectively. The first node may determine, based on a respective weight of the one or more conditions, the condition satisfaction value of the respective terminal to be a weighted sum of the respective satisfaction score of the respective terminal in satisfying each of the one or more conditions. Here, a weight corresponding to a condition may represent a priority of satisfying the condition. The higher a weight corresponding to a condition is, the higher the priority of satisfying the condition is.

As an example, the condition information is configured for determining 5 conditions, i.e., condition 1, condition 2, condition 3, condition 4, and condition 5. The 5 conditions correspond to weights w1, w2, w3, w4, and w5, respectively. The 5 weights add up to 1. The condition satisfaction value of the respective terminal may be determined by a formula as below:

$$w 1 * satisfaction score 1 + w 2 * satisfaction score 2 + w 3 * satisfaction score 3 + w 4 * satisfaction score 4 + w 5 * satisfaction score 5.$$

Satisfaction score 1 may refer to the satisfaction score in satisfying condition 1. Satisfaction score 2 may refer to the satisfaction score in satisfying condition 2. Satisfaction score 3 may refer to the satisfaction score in satisfying condition 3. Satisfaction score 4 may refer to the satisfaction score in satisfying condition 4. Satisfaction score 5 may refer to the satisfaction score in satisfying condition 5.

Note that as weights of all conditions add up to 1 and a satisfaction score in satisfying each condition is a number greater than or equal to 0 and less than or equal to 1, the computed condition satisfaction value of the respective terminal is within the range [0, 1].

In the solution, in an implementation, the respective weight may be included in the first request message, or the respective weight may be preconfigured.

In some implementations, the condition satisfaction value may be a quality of information (QoI) value. That is, the condition satisfaction circumstance may be represented by a QoI value. A name of the condition satisfaction value is not limited to the disclosure.

Note that as the first node selects the candidate terminal according to prediction and the selected candidate terminal may not satisfy a demand of the second node completely, the candidate terminal may be selected based on the weight corresponding to each condition. For example, the higher the weight corresponding to a condition is, the higher the probability that the candidate terminal selected by the first node satisfies the condition is.

In mode 2, the first node may determine whether the respective terminal satisfies each of the one or more conditions.

In mode 3, the first node may determine whether the respective terminal satisfies a specified condition among the one or more conditions.

There may be one or more specified conditions here.

In embodiments of the disclosure, after the first node receives the first request message from the second node, the first node may interact with at least one third node to acquire analysis information of the respective terminal from the at least one third node. Based on the analysis information of the respective terminal, the first node may determine the respective satisfaction score of the respective terminal in satisfying each of the one or more conditions, or determine whether the respective terminal satisfies each of the one or more conditions, or determine whether the respective terminal satisfies the specified condition among the one or more conditions.

In some implementations, the analysis information may include at least one of: mobility information, session information, or network performance information.

In some implementations, the at least one third node may include at least one of: a data analysis network element, a session management network element, or a mobility management network element. As an example, the data analysis network element may be a network data analytics function (NWDAF). The session management network element may be a session management function (SMF). The mobility management network element may be an access and mobility management function (AMF).

In embodiments of the disclosure, after determining the condition satisfaction circumstance of the respective terminal of the multiple terminals, the first node may determine the candidate terminal from the multiple terminals in a mode as follows.

In mode A, the first node may determine a terminal having a condition satisfaction value greater than or equal to a condition satisfaction threshold based on a condition satisfaction value of the respective terminal, and determine the terminal having the condition satisfaction value greater than or equal to the condition satisfaction threshold to be the candidate terminal.

In the solution, in an implementation, the condition satisfaction threshold may be included in the first request message. Alternatively, the condition satisfaction threshold may be preconfigured.

As an example, the first node may determine condition satisfaction values of 5 terminals. The condition satisfaction value of terminal 1 may be 0.95. The condition satisfaction value of terminal 2 may be 0.7. The condition satisfaction value of terminal 3 may be 0.85. The condition satisfaction value of terminal 4 may be 0.98. The condition satisfaction value of terminal 5 may be 0.6. The condition satisfaction threshold may be 0.8. Then, the first node may determine that condition satisfaction values of terminal 1, terminal 3, and terminal 4 are all greater than the condition satisfaction threshold, and the candidate terminals determined by the first node may include terminal 1, terminal 3, and terminal 4.

In mode B, the first node may determine a terminal satisfying all condition(s) determined by the condition information to be the candidate terminal.

Here, in the process of selecting the candidate terminal, the first node may determine a terminal satisfying all condition(s) determined by the condition information to be a candidate terminal, and directly exclude any terminal not satisfying any one or more conditions determined by the condition information or not satisfying one or more specified conditions among the one or more conditions determined by the condition information.

In mode C, the first node may determine a terminal satisfying one or more specified conditions determined by the condition information to be the candidate terminal.

In some implementations, the first node may determine respective candidate terminal corresponding respectively to one of one or more limiting conditions.

As an example, the one or more limiting conditions may be one or more time periods. The first node may determine respective candidate terminal corresponding respectively to one of the one or more time periods. For example, the first node determines respective candidate terminal corresponding respectively to one of 3 time periods. The respective candidate terminal corresponding respectively to one of the 3 time periods are as illustrated in Table 1 as follows.

TABLE 1

| Time period | Candidate terminal |
|---|---|
| Time period 1 | terminal 1, terminal 2, terminal 3, terminal 4, |
| | terminal 5 |
| Time period 2 | terminal 1, terminal 3, terminal 5, terminal 7, |
| | terminal 9 |
| Time period 3 | terminal 2, terminal 4, terminal 6, terminal 8, |
| | terminal 10 |

It may be seen from Table 1 that different time periods may correspond to different candidate terminals. This is because the condition satisfaction value of a terminal may vary over different time periods. A cause of the variation of the condition satisfaction value of the terminal may be a change in a respective satisfaction score of the terminal in satisfying a respective condition.

At operation 403, the first node sends a first request reply message to the second node. The first request reply message includes indication information for the candidate terminal.

In embodiments of the disclosure, the first node may send a first request reply message to the second node, and accordingly, the second node may receive the first request reply message from the first node. The first request reply message includes indication information for the candidate terminal.

Here, note that there may be one or more candidate terminals. The first request reply message may include indication information for the one or more candidate terminals.

In some implementations, the first request reply message may include identifier information of the one or more candidate terminals. The identifier information may indicate the candidate terminals. As an example, the first request reply message may include respective ID of the one or more candidate terminals.

In some implementations, the first request reply message may further include the respective condition satisfaction value of the one or more candidate terminals.

As an example, the condition satisfaction threshold is 0.8, and a terminal having a condition satisfaction value greater than or equal to 0.8 is a candidate terminal. Table 2 lists the condition satisfaction value of each candidate terminal.

TABLE 2

| Candidate | |
|---|---|
| terminal | Condition satisfaction value |
| terminal 1 | 0.95 |
| terminal 2 | 0.89 |
| terminal 3 | 0.85 |
| terminal 4 | 0.83 |
| terminal 5 | 0.81 |

In some implementations, in operation 402, the first node may determine respective candidate terminal corresponding respectively to one of one or more limiting conditions. Then, the first request reply message sent by the first node to the second node may include indication information for the respective candidate terminal corresponding respectively to one of the one or more limiting conditions. As an example, the first request reply message includes content as illustrated in Table 1.

In some implementations, after receiving the first request reply message from the first node, the second node may select one or more terminals from the candidate terminals to process the task.

Further, in an implementation, if the first request reply message includes the indication information for the respective candidate terminal corresponding respectively to one of the one or more limiting conditions (such as time periods), the second node selects one or more terminals from candidate terminals corresponding to different limiting conditions (such as time periods) to process tasks under the different limiting conditions (such as time periods). Taking Table 1 as an example, the second node selects terminal 1, terminal 2, and terminal 3 from candidate terminals corresponding to time period 1 to process the task within time period 1. The second node may select terminal 1, terminal 3, and terminal 5 from candidate terminals corresponding to time period 2 to process the task within time period 2. The second node may select terminal 2, terminal 4, and terminal 6 from candidate terminals corresponding to time period 3 to process the task within time period 3. A task here may be but is not limited to a federated learning task.

With a technical solution according to embodiments of the disclosure, the first node may serve the second node and enable the second node to acquire a proper candidate terminal. The first node may provide the second node with only indication information for the candidate terminal, therefore not exposing privacy of the candidate terminal (such as analysis information of the candidate terminal). In addition, the technical solution according to embodiments of the disclosure makes full use of existing architecture and signalling, has less impact on an existing protocol, and is easy to implement.

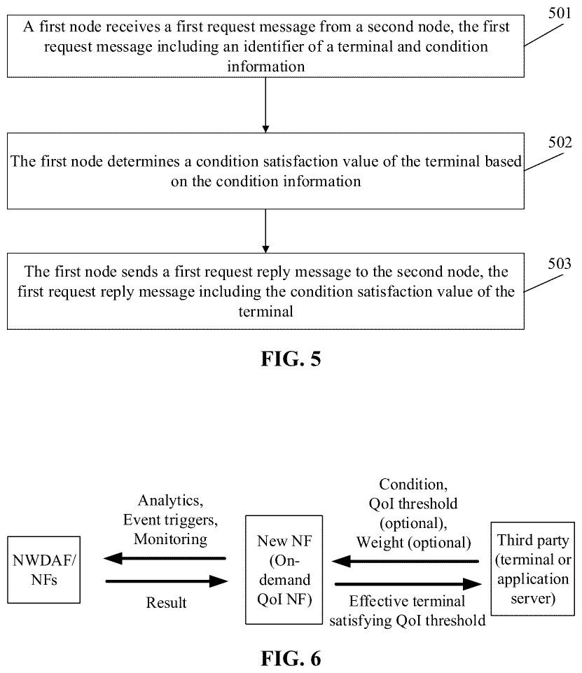

FIG. 5 is flowchart 2 of the communication method according to embodiments of the disclosure. As illustrated in FIG. 5, the communication method includes operations as follows.

At operation 501, a first node receives a first request message from a second node. The first request message includes an identifier of a terminal and condition information.

In some implementations, the first node may be a first core network element. Here, with respect to an existing core, the first core network element may be a new functional network element, or an existing functional network element. A name of the first core network element is not limited to the disclosure.

In some implementations, the second node may be a terminal or an application server.

In embodiments of the disclosure, the second node sends the first request message to the first node, and accordingly, the first node receives the first request message from the second node. Here, the first request message is configured for requesting for a condition satisfaction value of a terminal. Further, in an implementation, the first request message is configured for requesting for a result of determining whether the condition satisfaction value of the terminal is greater than or equal to a condition satisfaction threshold. The first request message includes the ID of the terminal and the condition information.

Here, note that there may be one or more terminals. In case of multiple terminals, the multiple terminals may correspond to the same condition information. Alternatively, at least part of the multiple terminals may correspond to different pieces of condition information.

In some implementations, the condition information is configured for determining at least one of: a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

Further, in some implementations, a condition determined by the condition information may further include an additional condition. The additional condition may include at least one of a condition satisfaction accuracy or a condition satisfaction effective time.

Here, the condition satisfaction accuracy may be represented by a confidence value. In other words, the confidence value may represent the accuracy of prediction of a condition satisfaction.

Here, the condition satisfaction effective time may refer to a time point when the condition is satisfied or a time period during which the condition is satisfied.

Note that whether a condition is satisfied or a probability that the condition is satisfied (corresponding to a satisfaction score in satisfying the condition in the solution below) may depend on just the condition per se, or may depend on both the condition per se and the additional condition associated with the condition. As an example, the additional condition of condition 1 is additional condition 1. As an implementation, the satisfaction score of condition 1 is deemed to be 100% in case condition 1 is satisfied. As another implementation, the satisfaction score of condition 1 is deemed to be 100% in case both condition 1 and the additional condition 1 are satisfied.

At operation 502, the first node determines a condition satisfaction value of the terminal based on the condition information.

In embodiments of the disclosure, the condition information is configured for determining one or more conditions. The first node may determine the condition satisfaction value of the terminal in a mode as follows.

The first node may determine a respective satisfaction score of the terminal in satisfying each of the one or more conditions, and determine the condition satisfaction value of the terminal based on the respective satisfaction score of the terminal in satisfying each of the one or more conditions.

In some implementations, a satisfaction score in satisfying a condition may be a number greater than or equal to 0 and less than or equal to 1, and represent a degree to which the condition is satisfied. As an example, satisfaction score 1 in satisfying a condition represents 100% satisfaction of the condition. Satisfaction score 0 in satisfying a condition represents that the condition is not satisfied. Satisfaction score X % in satisfying a condition represents probability X % that the condition is satisfied.

In some implementations, the condition satisfaction value may be a quality of information (QoI) value. A name of the condition satisfaction value is not limited to the disclosure.

In some implementations, the one or more conditions may have corresponding weight(s), respectively. The first node may determine, based on a respective weight of the one or more conditions, the condition satisfaction value of the respective terminal to be a weighted sum of the respective satisfaction score of the respective terminal in satisfying each of the one or more conditions. Here, a weight corresponding to a condition may represent a priority of satisfying the condition. The higher a weight corresponding to a condition is, the higher the priority of satisfying the condition is.

As an example, the condition information is configured for determining 5 conditions, i.e., condition 1, condition 2, condition 3, condition 4, and condition 5. The 5 conditions correspond to weights w1, w2, w3, w4, and w5, respectively. The 5 weights add up to 1. The condition satisfaction value of the respective terminal may be determined by a formula as below:

$$w 1 * satisfaction score 1 + w 2 * satisfaction score 2 + w 3 * satisfaction score 3 + w 4 * satisfaction score 4 + w 5 * satisfaction score 5.$$

Satisfaction score 1 may refer to the satisfaction score in satisfying condition 1. Satisfaction score 2 may refer to the satisfaction score in satisfying condition 2. Satisfaction score 3 may refer to the satisfaction score in satisfying condition 3. Satisfaction score 4 may refer to the satisfaction score in satisfying condition 4. Satisfaction score 5 may refer to the satisfaction score in satisfying condition 5.

Note that as weights of all conditions add up to 1 and the satisfaction score in satisfying each condition is a number greater than or equal to 0 and less than or equal to 1, the computed condition satisfaction value of the respective terminal is within the range [0, 1].

In the solution, in an implementation, the respective weight may be included in the first request message, or the respective weight is preconfigured.

Note that as the first node selects the candidate terminal according to prediction and the selected candidate terminal may not satisfy a demand of the second node completely, the candidate terminal may be selected based on the weight corresponding to each condition. For example, the higher the weight corresponding to a condition is, the higher the probability that the candidate terminal selected by the first node satisfies the condition is.

In embodiments of the disclosure, after the first node receives the first request message from the second node, the first node may interact with at least one third node to acquire analysis information of the terminal from the at least one third node. Based on the analysis information of the terminal, the first node may determine the respective satisfaction score of the terminal in satisfying each of the one or more conditions.

In some implementations, the analysis information may include at least one of: mobility information, session information, or network performance information.

In some implementations, the at least one third node may include at least one of: a data analysis network element, a session management network element, or a mobility management network element. As an example, the data analysis network element may be a network data analytics function (NWDAF). The session management network element may be a session management function (SMF). The mobility management network element may be an access and mobility management function (AMF).

Further, in some implementations, after determining the condition satisfaction value of the terminal, the first node may determine whether the condition satisfaction value of the terminal is greater than or equal to a condition satisfaction threshold. Specifically, the first node may compare the condition satisfaction value of the terminal to the condition satisfaction threshold to determine whether the condition satisfaction value of the terminal is greater than or equal to the condition satisfaction threshold.

In some implementations, the condition satisfaction threshold may be included in the first request message. Alternatively, the condition satisfaction threshold may be preconfigured.

As an example, the first node determines the condition satisfaction value of the terminal to be 0.95. The condition satisfaction threshold may be 0.8. Then, the first node may determine that the condition satisfaction value of the terminal is greater than the condition satisfaction threshold.

At operation 503, the first node sends a first request reply message to the second node. The first request reply message includes the condition satisfaction value of the terminal.

In embodiments of the disclosure, the first node sends a first request reply message to the second node, and accordingly, the second node receives the first request reply message from the first node. The first request reply message includes the condition satisfaction value of the terminal.

In some implementations, the first request reply message may further include first indication information. The first indication information may indicate whether the condition satisfaction value of the terminal is greater than or equal to the condition satisfaction threshold.

Here, note that there may be one or more terminals. The first request reply message may include a respective condition satisfaction value of the one or more terminals and/or respective first indication information for whether the respective condition satisfaction value of the one or more terminals is greater than or equal to a respective condition satisfaction threshold.

With the technical solution according to embodiments of the disclosure, the first node may serve the second node and enable the second node to perform analysis to acquire a condition satisfaction value of a terminal and/or to determine whether the condition satisfaction value of the terminal is greater than or equal to a condition satisfaction threshold. The first node may provide the second node with just the condition satisfaction value of the terminal, therefore not exposing privacy of a candidate terminal (such as analysis information of a candidate terminal). In addition, the technical solution according to embodiments of the disclosure makes full use of existing architecture and signalling, has less impact on an existing protocol, and is easy to implement.

FIG. 6 is a flowchart of interaction in the communication method according to embodiments of the disclosure. As illustrated in FIG. 6, a third party (a terminal or an application server) may send a first request message to a new network functional network element (NF) (i.e., the first node). The first request message may include condition information, a QoI threshold, and a weight. It is optional to include the QoI threshold and the weight. For example, it may be preconfigured to include the condition information, the QoI threshold, and the weight in the first request message. The new NF may convert a condition into an event defined in a 5GS (such as an analysis event, an event trigger event, a monitoring event, etc.), send the event to an NWDAF or other NFs (such as an SMF, an AMF, etc.), and acquire a result of the event from the NWDAF or the other NFs. For some condition, the new NF may direct map the condition to an event defined in the 5GS, such as a mobility prediction event, a QoS prediction event, etc. For some other condition, the NF may have to derive an event corresponding to the condition. After acquiring the result of the event, the new NF may determine a QoI score of the terminal in satisfying a respective condition according to the result, derive a QoI value of the terminal with reference to the weight of each of the one or more conditions, and recommend an effective terminal (i.e., a candidate terminal) to the third party (the terminal or the application server) by comparing the QoI value of the terminal to the QoI threshold. Note that a name of the new NF illustrated in FIG. 6 is not limited. As an example, the new NF is referred to as an on-demand QoI NE.

In the interaction flow illustrated in FIG. 6, the condition information provided by the third party (the terminal or the application server) to the new NF may include at least one of: a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition. Further, in the solution, it is measured against a respective threshold whether the rate condition, the time condition, the QoS condition, etc., is satisfied. For example, it is measured against a rate threshold whether the rate condition is satisfied. A terminal satisfies the rate condition if a rate of the terminal is greater than or equal to the rate threshold. For example, it is measured against a time threshold whether the time condition is satisfied. A terminal satisfies the time condition if the terminal stays at a specified region for a time period of at least the time threshold. For example, it is measured against a QoS threshold whether the QoS condition is satisfied. For some QoS parameters, a terminal satisfies the QoS condition if a QoS value of the terminal is greater than or equal to the QoS threshold. For some other QoS parameters, a terminal satisfies the QoS condition if the QoS value of the terminal is less than or equal to the QoS threshold.

The technical solution according to embodiments of the disclosure is illustrated hereinafter with reference to specific application examples. Note that an application example below is illustrated taking the condition satisfaction value being the QoI value as an example.

### Application Example 1

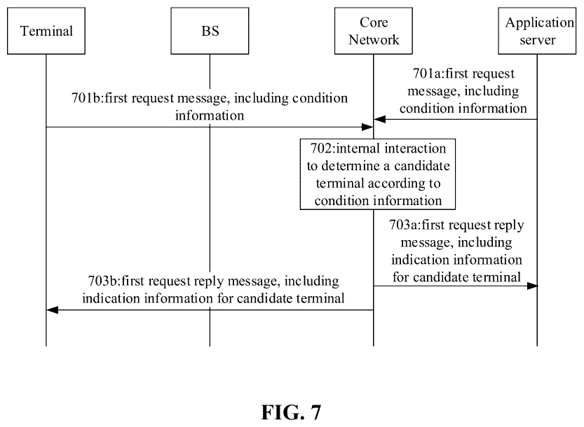

FIG. 7 is flowchart 3 of the communication method according to embodiments of the disclosure. As illustrated in FIG. 7, the communication method may include operations as follows.

At operation 701a/b, an application server or a terminal sends a first request message to a core network. The first request message includes condition information.

The first request message is configured for requesting for a recommended candidate terminal.

The first request message includes the condition information. A condition determined by the condition information may include but is not limited to at least one of: a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

Further, in some implementations, a condition determined by the condition information may further include an additional condition. The additional condition may include at least one of a condition satisfaction accuracy or a condition satisfaction effective time.

Here, the condition satisfaction accuracy may be represented by a confidence value. In other words, the confidence value may represent the accuracy of prediction of condition satisfaction.

Here, the condition satisfaction effective time may refer to a time point when the condition is satisfied or a time period during which the condition is satisfied.

At operation 702, the core network performs internal interaction to determine a candidate terminal according to the condition information.

Here, a network element interacting directly with the application server or the terminal may be referred to as a first core network element. With respect to an existing core network, the first core network element may be a new functional network element, or an existing functional network element. A name of the first core network element is not limited to the disclosure. The first core network element may perform internal interaction with another core network element to acquire analysis information of the terminal from the another core network element. In some implementations, the analysis information may include at least one of mobility information, session information, or network performance information. In some implementations, the another core network element may include at least one of a data analysis network element, a session management network element, or a mobility management network element. As an example, the data analysis network element may be a network data analytics function (NWDAF). The session management network element may be a session management function (SMF). The mobility management network element may be an access and mobility management function (AMF).

Based on the analysis information of the terminal, the first core network element may determine a respective satisfaction score of the terminal in satisfying a respective condition determined by the condition information. In some implementations, each of the one or more conditions, determined by the condition information, may correspond to a weight respectively. The first core network element may determine, based on the respective weight of each of the one or more conditions, a QoI value of the terminal to be a weighted sum of the respective satisfaction score of the terminal in satisfying each of the one or more conditions. Here, a weight corresponding to a condition may represent a priority of satisfying the condition. The higher a weight corresponding to a condition is, the higher the priority of satisfying the condition is.

As an example, the condition information is configured for determining 5 conditions, i.e., condition 1, condition 2, condition 3, condition 4, and condition 5. The 5 conditions correspond to weights w1, w2, w3, w4, and w5, respectively. The 5 weights add up to 1. The QoI value of the terminal may be determined by a formula below:

$$w 1 * satisfaction score 1 + w 2 * satisfaction score 2 + w 3 * satisfaction score 3 + w 4 * satisfaction score 4 + w 5 * satisfaction score 5.$$

Satisfaction score 1 may refer to the satisfaction score in satisfying condition 1. Satisfaction score 2 may refer to the satisfaction score in satisfying condition 2. Satisfaction score 3 may refer to the satisfaction score in satisfying condition 3. Satisfaction score 4 may refer to the satisfaction score in satisfying condition 4. Satisfaction score 5 may refer to the satisfaction score in satisfying condition 5.

Further, the first core network element may determine a terminal having a QoI value greater than or equal to a QoI threshold based on a QoI value of a respective terminal, and determine the terminal having the QoI value greater than or equal to the QoI threshold to be the candidate terminal.

As an example, the first core network element determines QoI values of 5 terminals. The QoI of terminal 1 may be 0.95. The QoI of terminal 2 may be 0.7. The QoI of terminal 3 may be 0.85. The QoI of terminal 4 may be 0.98. The QoI of terminal 5 may be 0.6. The QoI threshold may be 0.8. Then, the first core network element may determine that QoI values of terminal 1, terminal 3, and terminal 4 are all greater than the QoI threshold, and the candidate terminal determined by the first core network element may include terminal 1, terminal 3, and terminal 4.

In some implementations, the first core network element may determine respective candidate terminal corresponding respectively to one of one or more limiting conditions. As an example, the one or more limiting conditions are one or more time periods. The first node may determine respective candidate terminal corresponding respectively to one of the one or more time periods. For example, the first node determines respective candidate terminal corresponding respectively to one of 3 time periods. The respective candidate terminal corresponding respectively to one of the 3 time periods are as illustrated in Table 1.

It may be seen from Table 1 that different time periods correspond to different candidate terminals. This is because the QoI value of a terminal may vary over different time periods. A cause of variation of a QoI value of a terminal may be a change in a respective satisfaction score of the terminal in satisfying a respective condition.

At operation 703a/b, the core network may send a first request reply message to the application server or the terminal. The first request reply message may include indication information for the candidate terminal.

Here, note that there may be one or more candidate terminals. The first request reply message may include indication information for the one or more candidate terminals.

In some implementations, the first request reply message may further include the respective QoI value of the one or more candidate terminals.

As an example, the condition satisfaction threshold is 0.8, and a terminal having a condition satisfaction value greater than or equal to 0.8 is a candidate terminal. Table 2 lists the QoI value of each candidate terminal.

In some implementations, the core network may determine respective candidate terminal corresponding respectively to one of one or more limiting conditions. Then, the first request reply message may include indication information for the respective candidate terminal corresponding respectively to one of the one or more limiting conditions. As an example, the first request reply message includes content as illustrated in Table 1.

In some implementations, after receiving the first request reply message from the first node, the second node may select one or more terminals from the candidate terminal(s) to process the task.

Further, in an implementation, if the first request reply message includes the indication information for the respective candidate terminal corresponding respectively to one of the one or more limiting conditions (such as time periods), the second node selects one or more terminals from candidate terminals corresponding to different limiting conditions (such as time periods) to process tasks under the different limiting conditions (such as time periods). Taking Table 1 as an example, the second node selects terminal 1, terminal 2, and terminal 3 from candidate terminals corresponding to time period 1 to process the task within time period 1. The second node may select terminal 1, terminal 3, and terminal 5 from candidate terminals corresponding to time period 2 to process the task within time period 2. The second node may select terminal 2, terminal 4, and terminal 6 from candidate terminals corresponding to time period 3 to process the task within time period 3. A task here may be but is not limited to a federated learning task.

### Application Example 2

FIG. 8 is flowchart 4 of the communication method according to embodiments of the disclosure. As illustrated in FIG. 8, the communication method may include operations as follows.

At operation 801a/b, an application server or a terminal sends a first request message to a first core network element in a core network. The first request message includes condition information.

Here, a network element (in the core network) interacting directly with an application server or a terminal may be referred to as a first core network element. With respect to an existing core, the first core network element may be a new functional network element, or an existing functional network element. A name of the first core network element is not limited to the disclosure.

The first request message is configured for requesting for a recommended candidate terminal.

The first request message may include the condition information. A condition determined by the condition information may include but is not limited to at least one of: a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

In the solution, in an implementation, it is measured against a respective threshold whether the transmission rate condition, the speed condition, the time condition, the QoS condition, etc., is satisfied.

For example, it is measured against a transmission rate threshold whether the transmission rate condition is satisfied. A terminal satisfies the transmission rate condition if a transmission rate of the terminal is greater than or equal to the transmission rate threshold.

For example, it is measured against a speed threshold whether the speed condition is satisfied. A terminal satisfies the speed condition if a speed of the terminal is greater than or equal to the speed threshold.

For example, it is measured against a time threshold whether the time condition is satisfied. A terminal satisfies the time condition if the terminal stays at a specified region for a time period of at least the time threshold.

For example, it is measured against a QoS threshold whether the QoS condition is satisfied. For some QoS parameters, a terminal satisfies the QoS condition if a QoS value of the terminal is greater than or equal to the QoS threshold. For some other QoS parameters, a terminal satisfies the QoS condition if the QoS value of the terminal is less than or equal to the QoS threshold.

Further, in some implementations, a condition determined by the condition information may further include an additional condition. The additional condition may include at least one of a condition satisfaction accuracy or a condition satisfaction effective time.

Here, the condition satisfaction accuracy may be represented by a confidence value. In other words, the confidence value may represent the accuracy of prediction of condition satisfaction.

Here, the condition satisfaction effective time may refer to a time point when the condition is satisfied or a time period during which the condition is satisfied.

Further, in some implementations, the first request message may further include at least one of a QoI threshold or a weight corresponding to each condition determined by the condition information. Alternatively, the QoI threshold and/or the weight corresponding to each condition determined by the condition information may also be preconfigured.

At operation 802, the first core network element determines, based on content in the first request message, to request for analysis information of the terminal from an NWDAF in the core network.

At operation 803, the first core network element sends a second request message to the NWDAF. The second request message may be configured for requesting for the analysis information of the terminal.

Here, the analysis information of the terminal may include one or more pieces of analysis information. Each piece of analysis information may be represented by an analysis ID. Taking 2 pieces of analysis information as an example, Table 3 as follows gives the meaning of the 2 pieces of analysis information.

TABLE 3

| Analysis ID | Meaning | Analysis information |
|---|---|---|
| Analytics ID 1 | Network performance | QoS, etc. |
| Analytics ID 2 | UE mobility | UE location , etc. |

Here, the second request message may include one or more analysis IDs corresponding to the terminal. Further, for multiple terminals, the second request message may include one or more analysis IDs corresponding to each of the multiple terminals.

In some implementations, the second request message may further include identifier information of the terminal. The identifier information of the terminal may be associated with the one or more analysis IDs corresponding to the terminal, and may be configured to identify the terminal to which the one or more analysis IDs belong.

At operation 804, the NWDAF may send a second request reply message to the first core network element. The second request reply message may include the analysis information of the terminal.

Here, the second request reply message may include the analysis information of the terminal. Further, for multiple terminals, the second request message may include the analysis information of each of the multiple terminals.

In some implementations, the second request reply message may further include an accuracy (i.e., a confidence value) of the analysis information of the terminal.

At operation 805, based on the analysis information of the terminal, the first core network element may determine a respective satisfaction score of the terminal in satisfying a respective condition determined by the condition information, and determine, based on the respective weight of each of the one or more conditions, a QoI value of the terminal to be a weighted sum of the respective satisfaction score of the terminal in satisfying each of the one or more conditions. The first core network element may determine a terminal having a QoI value greater than or equal to the QoI threshold to be the candidate terminal.

As an example, the condition information is configured for determining 5 conditions, i.e., condition 1, condition 2, condition 3, condition 4, and condition 5. The 5 conditions correspond to weights w1, w2, w3, w4, and w5, respectively. The 5 weights add up to 1. The QoI value of the terminal may be determined by a formula below:

$$w 1 * satisfaction score 1 + w 2 * satisfaction score 2 + w 3 * satisfaction score 3 + w 4 * satisfaction score 4 + w 5 * satisfaction score 5.$$

Satisfaction score 1 may refer to the satisfaction score in satisfying condition 1. Satisfaction score 2 may refer to the satisfaction score in satisfying condition 2. Satisfaction score 3 may refer to the satisfaction score in satisfying condition 3. Satisfaction score 4 may refer to the satisfaction score in satisfying condition 4. Satisfaction score 5 may refer to the satisfaction score in satisfying condition 5.

For multiple terminals, the first core network element may acquire the QoI value of each of the multiple terminals.

As an example, the first core network element may determine QoI values of 5 terminals. The QoI of terminal 1 may be 0.95. The QoI of terminal 2 may be 0.7. The QoI of terminal 3 may be 0.85. The QoI of terminal 4 may be 0.98. The QoI of terminal 5 may be 0.6. The QoI threshold may be 0.8. Then, the first core network element may determine that QoI values of terminal 1, terminal 3, and terminal 4 are all greater than the QoI threshold, and the candidate terminals determined by the first core network element may include terminal 1, terminal 3, and terminal 4.

At operation 806a/b, the first core network element sends a first request reply message to the application server or the terminal. The first request reply message may include indication information for the candidate terminal.

Here, note that there may be one or more candidate terminals. The first request reply message may include indication information for the one or more candidate terminals.

In some implementations, the first request reply message may further include the respective QoI value of the one or more candidate terminals.

In some implementations, the core network may determine respective candidate terminal corresponding respectively to one of one or more limiting conditions. Then, the first request reply message may include indication information for the respective candidate terminal corresponding respectively to one of the one or more limiting conditions. As an example, the first request reply message includes content as illustrated in Table 1.

In some implementations, after receiving the first request reply message from the first node, the second node may select one or more terminals from the candidate terminal(s) to process the task.

Further, in an implementation, if the first request reply message includes the indication information for the respective candidate terminal corresponding respectively to one of the one or more limiting conditions (such as time periods), the second node selects one or more terminals from candidate terminals corresponding to different limiting conditions (such as time periods) to process tasks under the different limiting conditions (such as time periods). Taking Table 1 as an example, the second node selects terminal 1, terminal 2, and terminal 3 from candidate terminals corresponding to time period 1 to process the task within time period 1. The second node may select terminal 1, terminal 3, and terminal 5 from candidate terminals corresponding to time period 2 to process the task within time period 2. The second node may select terminal 2, terminal 4, and terminal 6 from candidate terminals corresponding to time period 3 to process the task within time period 3. A task here may be but is not limited to a federated learning task.

Implementations according to the disclosure are elaborated with reference to the drawings. However, the disclosure is not limited to specifics in the implementations. Multiple straightforward variations may be made to a technical solution of the disclosure within the scope of the technical concept of the disclosure. All of these straightforward variations fall in the scope of the disclosure. For example, respective specific technical features described in implementation may be combined in any suitable mode as long as no contradiction results. Various possible combinations are not described separately in the disclosure to avoid unnecessary repetition. As another example, various different implementations according to the disclosure may be combined as desired as long as the combination does not go against the concept of the disclosure, and the combination should also be deemed falling in the scope of the disclosure. As another example, embodiments illustrated in the disclosure and/or technical features in the embodiments may be combined with related art as needed, as long as no conflict results from the combination. A technical solution resulting from the combination shall also fall in the scope of the disclosure.

Further note that in various method embodiments of the disclosure, a magnitude of a sequence number of a foregoing process does not indicate an order in which the process is executed. The processes are to be executed in an order determined by functions and intrinsic logics of the processes. Such a sequence number shall constitute no limit to implementation of the embodiments of the disclosure. In addition, in embodiments of the disclosure, a term such as “downlink”, “uplink”, “sidelink”, etc., represents a transmission direction in which a signal or a data is transmitted. “Downlink” represents a first direction in which the signal or the data is transmitted from a station point to a terminal in a cell. “Uplink” represents a second direction in which the signal or the data is transmitted from the terminal in the cell to the station point. “Sidelink” represents a third direction in which the signal or the data is transmitted from terminal 1 to terminal 2. For example, a downlink signal is transmitted in the first direction. In addition, in embodiments of the disclosure, a term “and/or” describes an association between associated objects, including three possible relationships. Specifically, A and/or B may mean that there are three cases, namely, existence of just A, existence of both A and B, or existence of just B. In addition, a slash mark “/” in the disclosure generally represents an “or” relationship between two associated objects that come respectively before and after the mark per se.

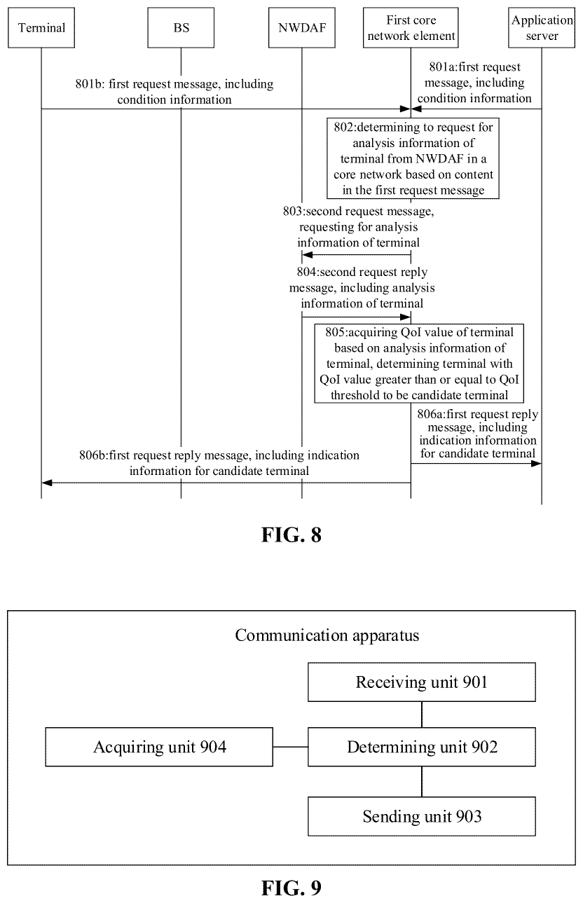

FIG. 9 is diagram 1 of a structural composition of a communication apparatus according to embodiments of the disclosure. The communication apparatus is applied to the first node. As illustrated in FIG. 9, the communication apparatus may include a receiving unit, a determining unit, and a sending unit.

The receiving unit 901 is configured to receive a first request message from a second node. The first request message includes condition information.

The determining unit 902 is configured to determine a condition satisfaction circumstance of a respective terminal of multiple terminals based on the condition information, and determine a candidate terminal from the multiple terminals based on the condition satisfaction circumstance of the respective terminal.

The sending unit 903 is configured to send a first request reply message to the second node. The first request reply message includes indication information for the candidate terminal.

In some implementations, the condition information is configured for determining one or more conditions. The determining unit 902 may be configured to determine a respective satisfaction score of the respective terminal in satisfying each of the one or more conditions, and determine a condition satisfaction value of the respective terminal based on the respective satisfaction score of the respective terminal in satisfying each of the one or more conditions; or determine whether the respective terminal satisfies each of the one or more conditions; or determine whether the respective terminal satisfies a specified condition among the one or more conditions.

In some implementations, the determining unit 902 is configured to determine, based on a respective weight of the one or more conditions, the condition satisfaction value of the respective terminal to be a weighted sum of the respective satisfaction score of the respective terminal in satisfying each of the one or more conditions.

In some implementations, the respective weight may be included in the first request message. Alternatively, the respective weight may be preconfigured.

In some implementations, the communication apparatus may further include an acquiring unit 904. The acquiring unit 904 is configured to, after the receiving unit 901 receives the first request message from the second node, interact with at least one third node to acquire analysis information of the respective terminal from the at least one third node.

The determining unit 902 may be configured to determine, based on the analysis information of the respective terminal, the respective satisfaction score of the respective terminal in satisfying each of the one or more conditions, or determine whether the respective terminal satisfies each of the one or more conditions, or determine whether the respective terminal satisfies the specified condition among the one or more conditions.

In some implementations, the analysis information may include at least one of mobility information, session information, or network performance information.

In some implementations, the at least one third node may include at least one of a data analysis network element, a session management network element, or a mobility management network element.

In some implementations, the determining unit 902 is configured to determine a terminal having a condition satisfaction value greater than or equal to a condition satisfaction threshold based on a condition satisfaction value of the respective terminal, and determine the terminal having the condition satisfaction value greater than or equal to the condition satisfaction threshold to be the candidate terminal; or determine a terminal satisfying all condition(s) determined by the condition information to be the candidate terminal; or determine a terminal satisfying one or more specified conditions determined by the condition information to be the candidate terminal.

In some implementations, the condition satisfaction threshold may be included in the first request message. Alternatively, the condition satisfaction threshold may be preconfigured.

In some implementations, the first request reply message may further include a condition satisfaction value of the candidate terminal.

In some implementations, the determining unit 902 is configured to determine respective candidate terminal corresponding respectively to one of one or more limiting conditions.

In some implementations, the one or more limiting conditions may be one or more time periods.

In some implementations, the first request reply message may include indication information for the respective candidate terminal corresponding respectively to one of the one or more limiting conditions.

In some implementations, the condition information is configured for determining at least one of.

a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

In some implementations, a condition determined by the condition information may further include an additional condition. The additional condition may include at least one of a condition satisfaction accuracy or a condition satisfaction effective time.

In some implementations, a condition satisfaction value may be represented by a quality of information (QoI) value.

In some implementations, the first node may be a first core network element.

In some implementations, the second node may be a terminal or an application server.

A person having ordinary skill in the art will understand illustration related to a foregoing communication apparatus according to embodiments of the disclosure by referring to illustration related to a communication method according to embodiments of the disclosure.

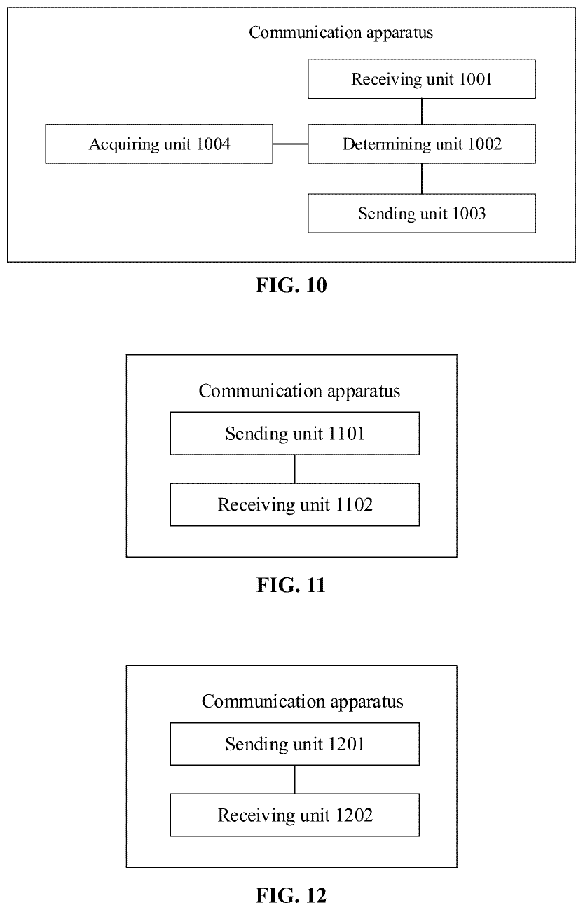

FIG. 10 is diagram 2 of the structural composition of the communication apparatus according to embodiments of the disclosure. The communication apparatus is applied to the first node. As illustrated in FIG. 10, the communication apparatus may include a receiving unit, a determining unit, and a sending unit.

The receiving unit 1001 is configured to receive a first request message from a second node. The first request message includes an identifier of a terminal and condition information.

The determining unit 1002 is configured to determine a condition satisfaction value of the terminal based on the condition information.

The sending unit 1003 is configured to send a first request reply message to the second node. The first request reply message includes the condition satisfaction value of the terminal.

In some implementations, the condition information is configured for determining one or more conditions. The determining unit 1002 may be configured to determine a respective satisfaction score of the terminal in satisfying each of the one or more conditions, and determine the condition satisfaction value of the terminal based on the respective satisfaction score of the terminal in satisfying each of the one or more conditions.

In some implementations, the determining unit 1002 is configured to determine, based on a respective weight of the one or more conditions, the condition satisfaction value of the terminal to be a weighted sum of the respective satisfaction score of the terminal in satisfying each of the one or more conditions.

In some implementations, the respective weight may be included in the first request message. Alternatively, the respective weight may be preconfigured.

In some implementations, the communication apparatus may further include an acquiring unit 1004. The acquiring unit 1004 is configured to, after the receiving unit 1001 receives the first request message from the second node, interact with at least one third node to acquire analysis information of the terminal from the at least one third node.

The determining unit 1002 may be configured to determine, based on the analysis information of the terminal, the respective satisfaction score of the terminal in satisfying each of the one or more conditions.

In some implementations, the analysis information may include at least one of mobility information, session information, or network performance information.

In some implementations, the at least one third node may include at least one of a data analysis network element, a session management network element, or a mobility management network element.

In some implementations, the determining unit 1002 is configured to determine whether the condition satisfaction value of the terminal is greater than or equal to a condition satisfaction threshold. The first request reply message may further include first indication information. The first indication information may indicate whether the condition satisfaction value of the terminal is greater than or equal to the condition satisfaction threshold.

In some implementations, the condition satisfaction threshold may be included in the first request message. Alternatively, the condition satisfaction threshold may be preconfigured.

In some implementations, the condition information is configured for determining at least one of

a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

In some implementations, a condition determined by the condition information may further include an additional condition. The additional condition may include at least one of a condition satisfaction accuracy or a condition satisfaction effective time.

In some implementations, the condition satisfaction value may be a quality of information (QoI) value.

In some implementations, the first node may be a first core network element.

In some implementations, the second node may be a terminal or an application server.

A person having ordinary skill in the art will understand illustration related to a foregoing communication apparatus according to embodiments of the disclosure by referring to illustration related to a communication method according to embodiments of the disclosure.

FIG. 11 is diagram 3 of the structural composition of the communication apparatus according to embodiments of the disclosure. The communication apparatus is applied to the second node. As illustrated in FIG. 11, the communication apparatus may include a sending unit and a receiving unit.

The sending unit 1101 is configured to send a first request message to a first node. The first request message includes condition information. The condition information is configured for the first node to determine a condition satisfaction circumstance of a respective terminal of multiple terminals, and determine a candidate terminal from the multiple terminals based on the condition satisfaction circumstance of the respective terminal.

The receiving unit 1102 is configured to receive a first request reply message from the first node. The first request reply message includes indication information for the candidate terminal.

In some implementations, the first request reply message may further include a condition satisfaction value of the candidate terminal.

In some implementations, the first request reply message may include indication information for a respective candidate terminal corresponding respectively to one of one or more limiting conditions.

In some implementations, the condition information is configured for determining at least one of:

a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

In some implementations, a condition determined by the condition information may further include an additional condition. The additional condition may include at least one of a condition satisfaction accuracy or a condition satisfaction effective time.

In some implementations, the condition satisfaction value may be represented by a quality of information (QoI) value.

In some implementations, the second node may be a terminal or an application server.

In some implementations, the first node may be a first core network element.

A person having ordinary skill in the art will understand illustration related to a foregoing communication apparatus according to embodiments of the disclosure by referring to illustration related to a communication method according to embodiments of the disclosure.

FIG. 12 is diagram 4 of the structural composition of the communication apparatus according to embodiments of the disclosure. The communication apparatus is applied to the second node. As illustrated in FIG. 12, the communication apparatus may include a sending unit and a receiving unit.

The sending unit 1201 is configured to send a first request message to a first node. The first request message includes an identifier of a terminal and condition information. The identifier of the terminal and the condition information are configured for the first node to determine a condition satisfaction value of the terminal.

The receiving unit 1202 is configured to receive a first request reply message from the first node. The first request reply message includes the condition satisfaction value of the terminal.

In some implementations, the first request reply message may further include first indication information. The first indication information may indicate whether the condition satisfaction value of the terminal is greater than or equal to a condition satisfaction threshold.

In some implementations, the condition satisfaction threshold may be included in the first request message. Alternatively, the condition satisfaction threshold may be preconfigured.

In some implementations, the condition information is configured for determining at least one of:

a terminal satisfied region condition, a terminal satisfied quantity condition, an inter-terminal satisfied spacing condition, a terminal satisfied transmission rate condition, a terminal satisfied speed condition, a terminal-stay-at-specified-region time condition, a terminal satisfied trajectory condition, a terminal satisfied quality of service (QoS) condition, or a terminal satisfied service capability condition.

In some implementations, a condition determined by the condition information may further include an additional condition. The additional condition may include at least one of a condition satisfaction accuracy or a condition satisfaction effective time.

In some implementations, the condition satisfaction value may be a quality of information (QoI) value.

In some implementations, the second node may be a terminal or an application server.

In some implementations, the first node may be a first core network element.

A person having ordinary skill in the art will understand illustration related to a foregoing communication apparatus according to embodiments of the disclosure by referring to illustration related to a communication method according to embodiments of the disclosure.

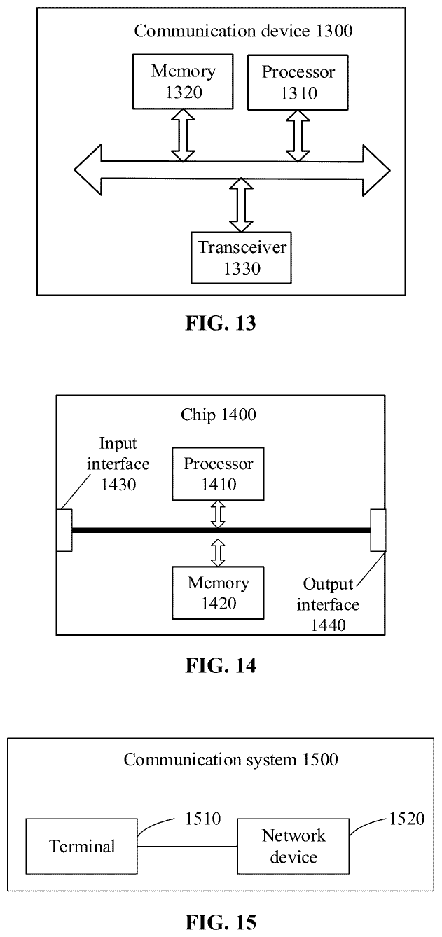

FIG. 13 is a diagram of a structure of a communication device 1300 according to embodiments of the disclosure. The communication device 1300 as illustrated in FIG. 13 may include a processor 1310. The processor 1310 may call and run a computer program in a memory to implement a method in embodiments of the disclosure.

In an implementation, as illustrated in FIG. 13, the communication device 1300 further includes a memory 1320. The processor 1310 may call and run a computer program in the memory 1320 to implement a method in embodiments of the disclosure.

The memory 1320 may be a separate device independent from the processor 1310, or may be integrated in the processor 1310.

In an implementation, as illustrated in FIG. 13, the communication device 1300 further includes a transceiver 1330. The processor 1310 may control communication by the transceiver 1330 with another device. Specifically, the transceiver transmits information or data to the other device, or receives information or data transmitted by the other device.

The transceiver 1330 may include a transmitter and a receiver. The transceiver 1330 may further include one or more antennas.

In an implementation, the communication device 1300 may be a network device (such as the first core network element) according to embodiments of the disclosure, and the communication device 1300 may implement a corresponding flow implemented by a network device in a method according to embodiments of the disclosure, which is not repeated here for brevity.

In an implementation, the communication device 1300 may be a mobile terminal/a terminal according to embodiments of the disclosure, and the communication device 1300 may implement a corresponding flow implemented by a mobile terminal/terminal in the method according to embodiments of the disclosure, which is not repeated here for brevity.

FIG. 14 is a diagram of a structure of a chip according to embodiments of the disclosure. The chip 1400 as illustrated in FIG. 14 may include a processor 1410. The processor 1410 may call and run a computer program in a memory to implement a method in embodiments of the disclosure.

In an implementation, as illustrated in FIG. 14, the chip 1400 may further include a memory 1420. The processor 1410 may call and run a computer program in the memory 1420 to implement the method in embodiments of the disclosure.

The memory 1420 may be a separate device independent from the processor 1410, or may be integrated in the processor 1410.

In an implementation, the chip 1400 may further include an input interface 1430. The processor 1410 may control communication by the input interface 1430 with another device or chip. Specifically, information or data transmitted by the other device or chip are acquired.

In an implementation, the chip 1400 may further include an output interface 1440. The processor 1410 may control communication by the output interface 1440 with another device or chip. Specifically, information or data are output to the other device or chip.

In an implementation, the chip may apply to a network device (such as the first core network element) in embodiments of the disclosure, and the chip may implement a flow implemented by a network device in the method according to embodiments of the disclosure, which is not repeated here for brevity.

In an implementation, the chip may apply to a mobile terminal/a terminal in embodiments of the disclosure, and the chip may implement a flow implemented by a mobile terminal/a terminal in the method according to embodiments of the disclosure, which is not repeated here for brevity.

Note that the chip mentioned in embodiments of the disclosure may also be referred to as a system-level chip, a system chip, a chip system, a SOC chip, etc.

FIG. 15 is a block diagram of a communication system 1500 according to embodiments of the disclosure. As illustrated in FIG. 15, the communication system 1500 may include a terminal 1510 and a network device 1520.

The terminal 1510 may be configured to implement a corresponding function implemented by a terminal in the method herein, and the network device 1520 may be configured to implement a corresponding function implemented by a network device in the method herein, which is not repeated here for brevity.

Note that the processor according to embodiments of the disclosure may be an integrated circuit chip capable of signal processing. In implementation, a step of a method embodiment herein may be carried out via an integrated logic circuit of hardware in the processor or instructions in form of software. The processor may be a general-purpose processor, a digital signal processor (DSP), an application specific integrated circuit (ASIC), a field programmable gate array (FPGA), or another programmable logic device, a discrete gate, or a transistor logic device, a discrete hardware component, etc. The processor may implement or execute various methods, steps, and logical block diagrams according to embodiments of the disclosure. A general-purpose processor may be a microprocessor or any conventional processor. A step of the method disclosed in embodiments of the disclosure may be directly embodied as being carried out by a hardware decoding processor, or by a combination of hardware and software modules in the decoding processor. A software module may be located in a mature storage medium in the art, such as a random access memory (RAM), a flash memory, a read only memory (ROM), a programmable read-only memory (PROM), an electrically rewritable programmable memory, a register, etc. The storage medium may be located in the memory. The processor may read information in the memory, and combine it with hardware of the processor to perform a step of a method herein.

Understandably, the memory in embodiments of the disclosure may be a volatile and/or a non-volatile memory. The non-volatile memory may be a read-only memory (ROM), a programmable ROM (PROM), an erasable PROM (EPROM), an electrically EPROM (EEPROM), or a flash memory, etc. The volatile memory may be a random access memory (RAM) serving as an external cache. By way of illustrative instead of restrictive description, there are many forms of RAM available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a direct rambus RAM (DR RAM), etc. Note that the memory of the system and method described herein is intended to include, but is not limited to, these and any other memory of suitable types.

Understandably, the foregoing memory is described in an illustrative nonrestrictive way. For example, the memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), etc. That is, a memory in embodiments of the disclosure is intended to include, but is not limited to, these and any other memory of suitable types.

Embodiments of the disclosure further provide a computer-readable storage medium configured to store a computer program.

In an implementation, the computer-readable storage medium may be applied to a network device (such as the first core network element) in embodiments of the disclosure, and the computer program allows a computer to execute a corresponding flow implemented by a network device in a method according to an embodiment of the disclosure, which is not repeated here for brevity.

In an implementation, the computer-readable storage medium may be applied to a mobile terminal/a terminal in embodiments of the disclosure, and the computer program allows a computer to execute a corresponding flow implemented by a mobile terminal/a terminal in the method according to an embodiment of the disclosure, which is not repeated here for brevity.

Embodiments of the disclosure further provide a computer program product including computer program instructions.

In an implementation, the computer program product may be applied to a network device (such as the first core network element) in embodiments of the disclosure, and the computer program instructions allows a computer to execute a corresponding flow implemented by a network device in the method according to an embodiment of the disclosure, which is not repeated here for brevity.

In an implementation, the computer program product may be applied to a mobile terminal/a terminal in embodiments of the disclosure, and the computer program instructions allows a computer to execute a corresponding flow implemented by a mobile terminal/terminal in the method according to an embodiment of the disclosure, which is not repeated here for brevity.

Embodiments of the disclosure further provide a computer program.

In an implementation, the computer program may be applied to a network device (such as the first core network element) in embodiments of the disclosure. When being run on a computer, the computer program allows the computer to execute a corresponding flow implemented by a network device in the method according to an embodiment of the disclosure, which is not repeated here for brevity.

In an implementation, the computer program may be applied to a mobile terminal/a terminal in embodiments of the disclosure. When being run on a computer, the computer program allows the computer to execute a corresponding flow implemented by a mobile terminal/a terminal in the method according to an embodiment of the disclosure, which is not repeated here for brevity.

A person having ordinary skill in the art may realize that a unit and an algorithm step in an example according to embodiments of the disclosure may be implemented by electronic hardware or a combination of electronic hardware and computer software. Whether such a function is implemented by hardware or by software depends on a specific application of a technical solution as well as a design constraint. Depending on a specific application, a person having ordinary skill in the art may implement a described function using different methods. Such implementations however should not be deemed going beyond a scope of the disclosure.

A person having ordinary skill in the art will clearly understand that, for convenience and conciseness of description, reference may be made to a corresponding process in a foregoing method embodiment for a detailed working process of a system, an apparatus, a unit, etc., described above, which is not repeated here.

In a number of embodiments provided in the disclosure, it should be understood that a method, an apparatus, a system, etc., as disclosed, may be implemented in other ways. For example, a described apparatus embodiment is merely illustrative. For example, division of units is merely logic function division and there may be another division in actual implementation. For example, units or components may be combined, or integrated into another system, or some features/characteristics may be omitted or skipped. Furthermore, the coupling, or direct coupling or communicational connection illustrated or discussed herein may be implemented through indirect coupling or communicational connection among some interfaces, apparatuses, or units, and may be electrical, mechanical, or of another form.

The units described as separate components may or may not be physically separated. Components shown as units may be or may not be physical units. They may be located in one place, or distributed on multiple network units. Some or all of the units may be selected to achieve the purpose of a solution of the embodiments as needed.

In addition, functional units in embodiments of the disclosure may be integrated in one processing part, or exist as separate physical units respectively. Alternatively, two or more units may be integrated in one unit.

When implemented in form of a software functional unit and sold or used as an independent product, the function may be stored in a computer-readable storage medium. Based on such an understanding, the essential part or a part contributing to prior art of the technical solution of the disclosure or part of the technical solution may appear in form of a software product. The software product is stored in a storage medium, and includes a number of instructions for allowing computer device (such as a personal computer, a server, network device, etc.) to execute all or part of a method in an embodiment of the disclosure. The storage medium includes various media that may store program codes, such as a U disk, a mobile hard disk, Read-Only Memory (ROM), Random Access Memory (RAM), a magnetic disk, a CD, etc.

What described are just embodiments of the disclosure and are not intended to limit the scope of the disclosure. Any modification, equivalent replacement, and/or the like made within the technical scope of the disclosure, as may occur to a person having ordinary skill in the art, shall be included in the scope of the disclosure. The scope of the disclosure thus should be determined by the claims.

1. A communication method, comprising:
receiving, by a first node, a first request message from a second node, the first request message comprising condition information;
determining, by the first node, a condition satisfaction circumstance of a respective terminal of multiple terminals based on the condition information, and determining a candidate terminal from the multiple terminals based on the condition satisfaction circumstance of the respective terminal; and
sending, by the first node, a first request reply message to the second node, the first request reply message comprising indication information for the candidate terminal.

2. The communication method of claim 1, wherein the condition information is configured for determining one or more conditions,
wherein determining, by the first node, the condition satisfaction circumstance of the respective terminal based on the condition information comprises:
determining, by the first node, a respective satisfaction score of the respective terminal in satisfying each of the one or more conditions, and determining a condition satisfaction value of the respective terminal based on the respective satisfaction score of the respective terminal in satisfying each of the one or more conditions; or
determining, by the first node, whether the respective terminal satisfies each of the one or more conditions; or
determining, by the first node, whether the respective terminal satisfies a specified condition among the one or more conditions.

3. The communication method of claim 2, further comprising: after receiving, by the first node, the first request message from the second node, interacting by the first node with at least one third node and acquiring analysis information of the respective terminal from the at least one third node.

4. The communication method of claim 3, wherein determining, by the first node, the respective satisfaction score of the respective terminal in satisfying each of the one or more conditions comprises:
determining, by the first node based on the analysis information of the respective terminal, whether the respective terminal satisfies each of the one or more conditions.

5. The communication method of claim 4, wherein the at least one third node comprises at least one of followings: a data analysis network element, a session management network element, or a mobility management network element.

6. The communication method of claim 1, wherein determining the candidate terminal from the multiple terminals based on the condition satisfaction circumstance of the respective terminal comprises:
determining, by the first node, a terminal having a condition satisfaction value greater than or equal to a condition satisfaction threshold based on a condition satisfaction value of the respective terminal, and determining the terminal having the condition satisfaction value greater than or equal to the condition satisfaction threshold to be the candidate terminal; or
determining, by the first node, a terminal satisfying all condition(s) determined by the condition information to be the candidate terminal; or
determining, by the first node, a terminal satisfying one or more specified conditions determined by the condition information to be the candidate terminal.

7. The communication method of claim 1, wherein the condition information is configured for determining at least one of following conditions:
a terminal satisfied region condition, an inter-terminal satisfied spacing condition, or a terminal satisfied quality of service (QoS) condition.

8. The communication method of claim 1, wherein the first node is a first core network element, or the second node is a terminal or an application server.

9. A communication method, comprising:
sending, by a second node, a first request message to a first node, the first request message comprising condition information, wherein the condition information is configured for the first node to determine a condition satisfaction circumstance of a respective terminal of multiple terminals and determine a candidate terminal from the multiple terminals based on the condition satisfaction circumstance of the respective terminal; and
receiving, by the second node, a first request reply message from the first node, the first request reply message comprising indication information for the candidate terminal.

10. The communication method of claim 9, wherein the condition information is configured for determining one or more conditions,
wherein the condition satisfaction circumstance of the respective terminal is determined by:
determining a respective satisfaction score of the respective terminal in satisfying each of the one or more conditions, and determining a condition satisfaction value of the respective terminal based on the respective satisfaction score of the respective terminal in satisfying each of the one or more conditions; or
determining whether the respective terminal satisfies each of the one or more conditions; or
determining whether the respective terminal satisfies a specified condition among the one or more conditions.

11. The communication method of claim 10, wherein the condition information is configured for the first node to interact with at least one third node and acquire analysis information of the respective terminal from the at least one third node.

12. The communication method of claim 11, wherein the analysis information of the respective terminal is used for the first node to determine whether the respective terminal satisfies each of the one or more conditions.

13. The communication method of claim 12, wherein the at least one third node comprises at least one of followings: a data analysis network element, a session management network element, or a mobility management network element.

14. The communication method of claim 9, wherein the condition information is configured for determining at least one of:
a terminal satisfied region condition, an inter-terminal satisfied spacing condition, or a terminal satisfied quality of service (QoS) condition.

15. A communication apparatus, comprising a processor and a transceiver connected to the processor,
wherein the transceiver is configured to receive a first request message from a second node, the first request message comprising condition information,
the processor is configured to determine a condition satisfaction circumstance of a respective terminal of multiple terminals based on the condition information, and determine a candidate terminal from the multiple terminals based on the condition satisfaction circumstance of the respective terminal, and
the transceiver is configured to send a first request reply message to the second node, the first request reply message comprising indication information for the candidate terminal.

16. The communication apparatus of claim 15, wherein the condition information is configured for determining one or more conditions,
wherein the processor is further configured to:
determine a respective satisfaction score of the respective terminal in satisfying each of the one or more conditions, and determining a condition satisfaction value of the respective terminal based on the respective satisfaction score of the respective terminal in satisfying each of the one or more conditions; or
determine whether the respective terminal satisfies each of the one or more conditions; or
determine whether the respective terminal satisfies a specified condition among the one or more conditions.

17. The communication apparatus of claim 16, wherein the transceiver is further configured to:
after receiving the first request message from the second node, interact with at least one third node and acquire analysis information of the respective terminal from the at least one third node.

18. The communication apparatus of claim 17, wherein the processor is further configured to:
determine whether the respective terminal satisfies each of the one or more conditions based on the analysis information of the respective terminal.

19. The communication apparatus of claim 18, wherein the at least one third node comprises at least one of followings: a data analysis network element, a session management network element, or a mobility management network element.

20. The communication apparatus of claim 15, wherein the condition information is configured for determining at least one of following conditions:
a terminal satisfied region condition, an inter-terminal satisfied spacing condition, or a terminal satisfied quality of service (QoS) condition.
